(19) United States
(12) Patent Application Publication
(10) Pub. No.: US 2025/0389308 A1
(43) Pub. Date: Dec. 25, 2025

(54) HEAT DISSIPATION ASSEMBLY OF BICYCLE DISC BRAKE PAD

(71) Applicant: Huang-Chieh Metal Composite Material Tech. Co., Ltd., New Taipei City (TW)

(72) Inventor: Chin-Han Wang, New Taipei City (TW)

(21) Appl. No.: 18/749,008

(22) Filed: Jun. 20, 2024

(51) Int. Cl. F16D 65/847; F16D 65/78

(52) U.S. Cl. CPC F16D 65/847; F16D 2065/789

(57) ABSTRACT

A heat dissipation assembly of bicycle disc brake pads including a heat dissipation member and a friction member is provided. The heat dissipation member made of metal sheets includes a first surface and a second surface disposed on two opposites sides thereof. The heat dissipation member has a heat dissipation area and a joining area on which the friction member is fixed. At least one heat dissipation part is disposed on the heat dissipation area, without extending through the heat dissipation area, and having a convex surface and a concave surface respectively formed on the first surface and the second surface by stamping. A heat dissipation area of the heat dissipation member in contact with air or air flows is increased by the convex and concave surfaces of the heat dissipation part so that heat dissipation performance of the disc brake pad is improved.

### FIELD OF THE INVENTION

The present invention relates to a bicycle disc brake, especially to a heat dissipation assembly of bicycle disc brake pads.

### BACKGROUND OF THE INVENTION

Brake pads are important components of disc brakes (disc actuators) and the driving safety rides on performance of the brake pads. In order to prevent brake pad fade caused by high temperature and further avoid brake failure, people in the business provide a brake pad with a self-heat-dissipation function which has better heat dissipation performance for preventing problems caused by high temperature.

The brake pad with the self-heat-dissipation function is mainly composed of a metal sheet and friction plates. High heat from the friction plates are removed by good thermal conductivity of the metal sheet. In order to increase heat dissipation capability of the brake pad, the brake pad with the self-heat-dissipation function is based on increased heat dissipation area of the metal sheet.

As a typical passive heat dissipating element, the conventional heat dissipation metal sheet can dissipate heat without additional driving energy. Fins of fin-type heat sinks are used for increasing the amount of heat transferred which is proportional to heat transfer area, heat transfer coefficient, and temperature difference. The heat transfer can be improved by larger heat transfer area, higher heat transfer coefficient, and wider temperature difference. However, the wider temperature difference is not feasible because working temperatures are usually limited. The most common way is to enhance the heat transfer coefficient or increase the heat transfer area.

Refer to Taiwanese Pat. No. 1526636, an improved brake lining heat-dissipation structure is provided. The brake lining heat-dissipation structure includes a mina body composed of a heat dissipation section and a connection section to which a brake block is mounted. The heat dissipation section is provided with a plurality of through holes penetrating the main body an arranged in parallel to one another. Each of the through holes is connected with a fin extending outward from the main body.

The patent mentioned above, the fins are produced by stamping and the through holes are formed on the heat dissipation section. Compared with stamped products with complicated structures and no through holes, stamping technique for creating through holes on the stamped products is easier. Yet the fin of the brake lining is easy to have a cut and get broken. Thus heat transfer path between the fins and the heat dissipation section is blocked at the through holes. Besides reduction of heat transfer area of the fins, the heat transfer area between the brake lining and the fin is limited to a section of the fin. Thereby heat transfer efficiency is reduced.

### SUMMARY

Therefore, it is a primary object of the present invention to provide a heat dissipation assembly of bicycle disc brake pads with larger heat dissipation area for better heat dissipation performance of the disc brake pad.

In order to achieve the above objects, a heat dissipation assembly of bicycle disc brake pads according to the present invention includes a heat dissipation member and a friction member. The heat dissipation member is made of metal sheets and two opposite sides of the heat dissipation member are provided with a first surface and a second surface correspondingly. The heat dissipation member has a heat dissipation area and a joining area. The friction member is fixed on the joining area and a heat dissipation part is disposed on the heat dissipation area. The heat dissipation part is provided with a convex surface formed on the first surface by stamping and a concave surface formed on the second surface by stamping and corresponding to the convex surface. The heat dissipation part is not extending through the heat dissipation area of the heat dissipation member.

Preferably, the heat dissipation area is provided with a plurality of heat dissipation parts and a gap is formed between the two adjacent heat dissipation parts.

Preferably, a ratio of a depth to a width of the concave surface of the heat dissipation part is ranging from 1:1 to 1:2.

The present assembly features on that production of the heat dissipation part by stamping is convenient and cost-effective. The heat dissipation part includes a convex surface projecting from the first surface of the disc brake pad and a concave surface formed on the second surface and corresponding to the convex surface. The heat dissipation part is not extending through the heat dissipation area of the heat dissipation member. By the convex and concave surfaces of the heat dissipation part, a heat dissipation area of the heat dissipation member in contact with air or air flows is increased and heat dissipation performance of the disc brake pad is further improved.

### BRIEF DESCRIPTION OF THE DRAWINGS

FIG. 1 is a front view of an embodiment of a heat dissipation assembly of bicycle disc brake pads according to the present invention;

FIG. 2 is right view of the embodiment in FIG. 1 according to the present invention;

FIG. 3 is a sectional view of a line A-A of the embodiment in FIG. 1 according to the present invention;

FIG. 4 is a perspective view of an embodiment according to the present invention;

FIG. 5 is a rear view of the embodiment in FIG. 4 according to the present invention.

### DETAILED DESCRIPTION

In the following descriptions and figures of embodiments according to the present invention, directions mentioned (such as upper, lower, left, right, front and rear) are defined according to related figures and used for showing structure or relationship (such as positions, connections, and actions) among respective components. In principle, the directions described are proper when positions of the components or the structure mentioned in the specifications matches those in figures. Once the positions of the components or the structure mentioned in the specifications change, the directions described should have corresponding changes.

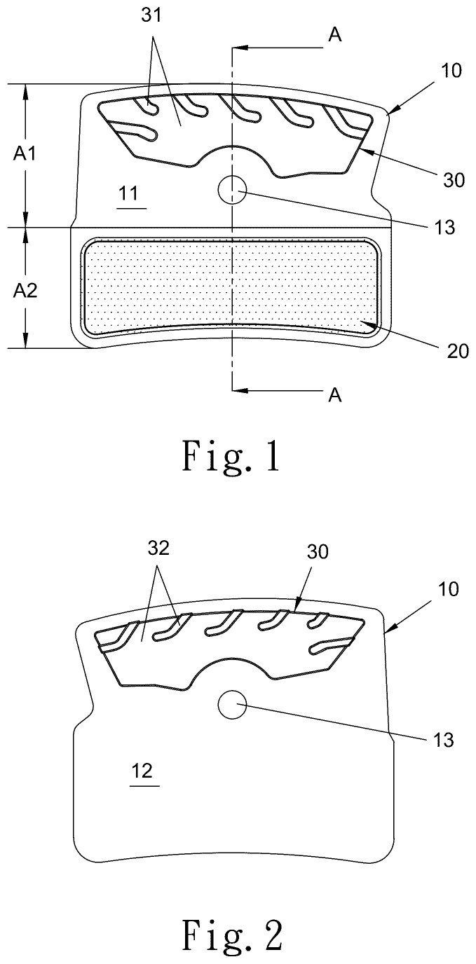

Refer to FIG. 1 and FIG. 2, a heat dissipation assembly of bicycle disc brake pads according to the present invention includes a heat dissipation member 10 and a friction member 20.

A first surface 11 and a second surface 12 are disposed on two opposites sides of the heat dissipation member 10 correspondingly and the heat dissipation member 10 is made of metal sheets. The heat dissipation member 10 includes a heat dissipation area A1 and a joining area A2. The friction member 20 is mounted and fixed on the joining area A2 for removal of heat generated from the friction member 20 during working by good thermal conductivity of the metal sheet.

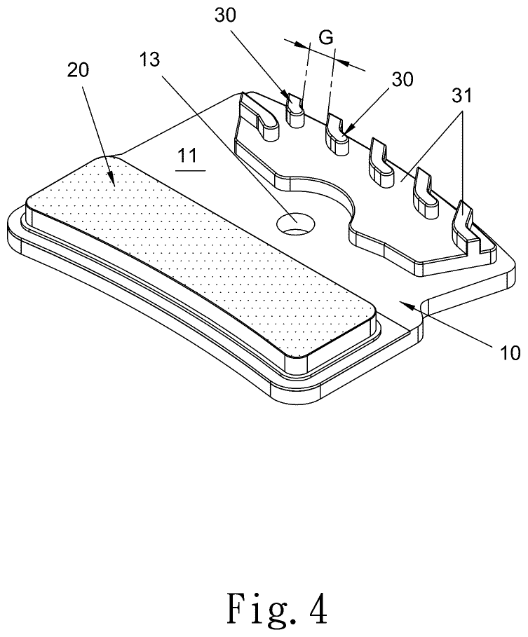

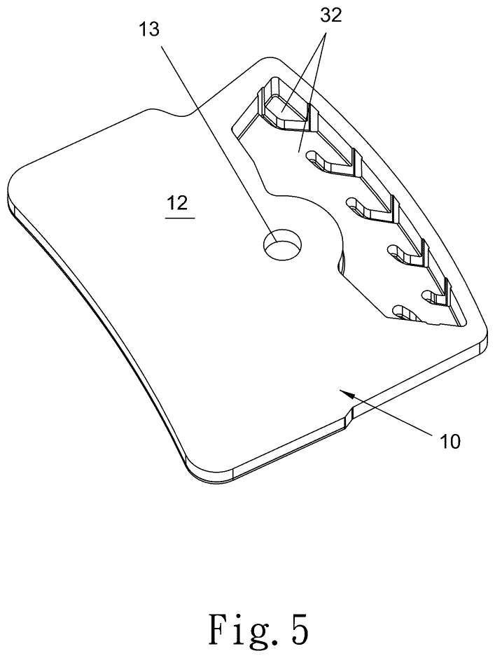

Refer to FIG. 4 and FIG. 5, the heat dissipation member 10 is produced by a metal sheet and mounted to a brake system of a bicycle frame by an assembly hole 13. The metal sheet includes an aluminum alloy plate or an aluminum-alloy-steel clad metal sheet which provides reliable structure strength to avoid deformation during high temperature. At the same time, excellent thermal conductivity of the metal sheet provides the disc brake pad superior heat transfer and heat dissipation.

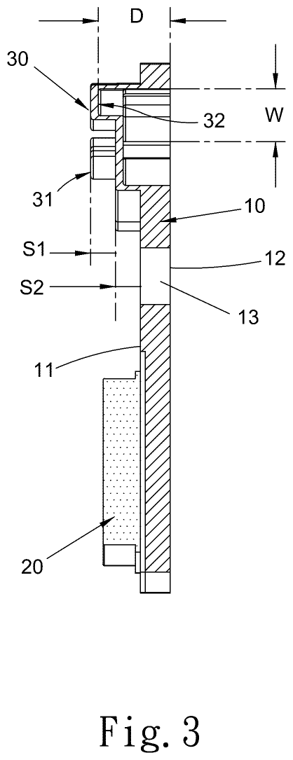

In a preferred embodiment, the heat dissipation area A1 of the heat dissipation member 10 is provided with a heat dissipation part 30 which consists of a convex surface 31 formed on the first surface 11 by stamping and a concave surface 32 formed on the second surface 12 by stamping and corresponding to the convex surface 31, as shown in FIG. 3. The heat dissipation part 30 is not extending through the heat dissipation area A1 of the heat dissipation member 10. In other words, the convex surface 31 and the concave surface 32 are not communicating with each other. Air or air flows respectively passed through the first surface 11 and the second surface 12 of the heat dissipation member 10 of the disc brake pad are separated by the heat dissipation part 30, as shown in FIG. 3. The heat generated from the friction member 20 during operation is firstly transferred to the heat dissipation area A1 through the heat dissipation member 10. Then the heat is further dissipated by heat convection between the heat dissipation part 30 on the heat dissipation area A1 and air or air flow.

In a preferred embodiment shown in FIG. 4, the heat dissipation area A1 is provided with a plurality of heat dissipation parts 30 and a gap G is formed between the two adjacent heat dissipation parts 30 through which air flows to cool down. Each of the heat dissipation parts 30 includes a plurality of steps at different levels. For example, the steps include a first step S1 and a second step S2 (as shown in FIG. 3). In another preferred embodiment, the heat dissipation parts 30 can be designed to have different shapes according to a direction of relative movement between the disc brake pad and air flows for creating disturbance and extending contact time between the air flows and the heat dissipation parts 30 for better heat dissipation.

In a preferred embodiment shown in FIG. 3, a ratio of a depth D to a width W of the concave surface 32 of the heat dissipation part 30 is ranging from 1:1 to 1:2. The above depth D to width W ratio range of the concave surface 32 is achieved through excellent stamping technique so that heat dissipation area of the disc brake pad can be significantly increased and heat dissipation performance of the disc brake pad is further improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A heat dissipation assembly of a bicycle disc brake pad comprising
a heat dissipation member and a friction member;
the heat dissipation member made of metal sheets and having a first surface and a second surface disposed on two opposite sides of the heat dissipation member correspondingly; the heat dissipation member including a heat dissipation area and a joining area and the friction member being fixed on the joining area;
wherein at least one heat dissipation part is arranged at the heat dissipation area; the heat dissipation part is provided with a convex surface and a concave surface respectively formed on the first surface and the second surface by stamping and corresponding to each other; the heat dissipation part is not extending through the heat dissipation area of the heat dissipation member.

2. The assembly as claimed in claim 1, wherein the heat dissipation area is provided with a plurality of the heat dissipation parts and a gap is formed between the two adjacent heat dissipation parts.

3. The assembly as claimed in claim 1, wherein a ratio of a depth to a width of the concave surface of the heat dissipation part is ranging from 1:1 to 1:2.
